(19) United States
(12) Patent Application Publication
(10) Pub. No.: US 2026/0244380 A1
(43) Pub. Date: Aug. 20, 2026

(54) STORAGE MEDIUM STORING APPLICATION PROGRAM, CONTROL METHOD, AND INFORMATION PROCESSING APPARATUS

(71) Applicant: CANON KABUSHIKI KAISHA, Tokyo (JP)

(72) Inventor: TAKUMI EBIHARA, Kanagawa (JP)

(21) Appl. No.: 19/530,412

(22) Filed: Feb. 5, 2026

(30) Foreign Application Priority Data
Feb. 18, 2025 (JP) 2025-024273

(51) Int. Cl. G06F 3/12

(52) U.S. Cl. CPC G06F 3/1256; G06F 3/1205; G06F 3/1228

(57) ABSTRACT

A non-transitory computer-readable storage medium storing an application program. The application program causes a computer of an information processing apparatus to execute a control method. The control method includes supporting a standard driver provided from a provider of an operating system, displaying a setting reception screen for receiving a punched hole setting for causing an image forming system having a punched hole-forming function which can form punched hole sets each formed by a plurality of punched holes, at a plurality of positions, to execute the punched hole-forming function, and instructing execution of the punched hole-forming function based on the punched hole setting received on the setting reception screen.

### BACKGROUND

### Field of the Technology

The present disclosure relates to a storage medium storing an application program, a control method, and an information processing apparatus.

### Description of the Related Art

In recent years, there is known a general-purpose printer driver (standard driver) that communicates with an image forming apparatus using a printing-industry standard protocol, such as the Internet Printing Protocol (IPP). The general-purpose printer driver can communicate with the image forming apparatus regardless of e.g. the type of the image forming apparatus. With this, it is possible to transmit a print job to the image forming apparatus without installing a printer driver determined for each type of the image forming apparatus, i.e., a printer driver specific to each vendor supplying an image forming apparatus. Thus, the general-purpose printer driver is excellent in versatility, but on the other hand, an item and a function, which can be set as print settings, are limited. To cope with this, Japanese Laid-Open Patent Publication (Kokai) No. 2020-004159 discloses a printing extension application causing the general-purpose printer driver to extend the limited item and function.

The printer driver is a printer driver different for each vendor supplying an image forming apparatus as mentioned above, i.e., a model-specific printer driver suitable for each image forming apparatus. As this printer driver, there is a driver that is capable of causing an image forming apparatus having a punched hole-forming function of forming a plurality of pairs of punched holes to execute the punched hole-forming function. On the other hand, the general-purpose printer driver has a problem of incapability of causing the image forming apparatus to execute the punched hole-forming function.

### SUMMARY

The present disclosure is directed to providing a mechanism that makes it possible to cause an image forming system to execute a punched hole-forming function even in a case where a standard driver is used.

In a first aspect of the present disclosure, there is provided a non-transitory computer-readable storage medium storing an application program, the application program causing a computer of an information processing apparatus to execute a control method, the control method including supporting a standard driver provided from a provider of an operating system, displaying a setting reception screen for receiving a punched hole setting for causing an image forming system having a punched hole-forming function which can form punched hole sets each formed a plurality of punched holes, at a plurality of positions, to execute the punched hole-forming function, and instructing execution of the punched hole-forming function based on the punched hole setting received on the setting reception screen.

In a second aspect of the present disclosure, there is provided a control method including supporting a standard driver provided from a provider of an operating system, displaying a setting reception screen for receiving a punched hole setting for causing an image forming system having a punched hole-forming function which can form punched hole sets each formed a plurality of punched holes, at a plurality of positions, to execute the punched hole-forming function, and instructing execution of the punched hole-forming function based on the punched hole setting received on the setting reception screen.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a printing system.

FIGS. 2A to 2D are block diagrams showing respective hardware configurations of apparatuses included in the printing system.

FIG. 3 is an appearance view of a printer.

FIGS. 4A to 4D are diagrams each showing a printed matter formed with a punched hole set.

FIG. 5 is a sequence diagram showing a process executed between an application management service, an online support service, an OS of a client terminal, and the printer.

FIG. 6 is a diagram showing an example of capabilities information of the printer.

FIG. 7 is a diagram showing an example of a setup screen displayed on a display section of the client terminal.

FIG. 8 is a diagram showing an example of device capabilities information in an initial state, which is packaged in the OS.

FIG. 9 is a diagram showing an example of the updated device capabilities information.

FIG. 10 is a diagram showing an example of an extension setup information file.

FIG. 11A is a sequence diagram showing a process executed between a print setting-extending application, a document generation application, the OS, and the printer.

FIG. 11B is a diagram showing a print setting screen displayed on the display section of the client terminal, on which an operation of selecting a print queue can be performed.

FIGS. 12A to 12G are diagrams each showing a detailed setting screen displayed on the display section of the client terminal, on which detailed conditions for printing can be set.

FIG. 13 is a diagram showing a variation of the detailed setting screen displayed on the display section of the client terminal, on which detailed conditions for printing can be set.

FIG. 14A and FIGS. 14B to 14D are a diagram showing a print setting screen, and diagrams each showing a detailed setting screen displayed on the display section of the client terminal, on which detailed conditions for printing can be set, respectively.

FIG. 15 is a flowchart of a process for installing the print setting-extending application into the client terminal.

FIG. 16 is a flowchart of a process for making print settings using the print setting-extending application and generating print data.

### DESCRIPTION OF THE EMBODIMENTS

The present disclosure will now be described in detail below with reference to the accompanying drawings showing embodiments thereof. The configuration described in the following embodiments is given only by way of example, and is by no means intended to limit the scope of the present disclosure. For example, components of the configuration of the present disclosure can be replaced with desired components which can exhibit the same functions. Further, desired components can be added.

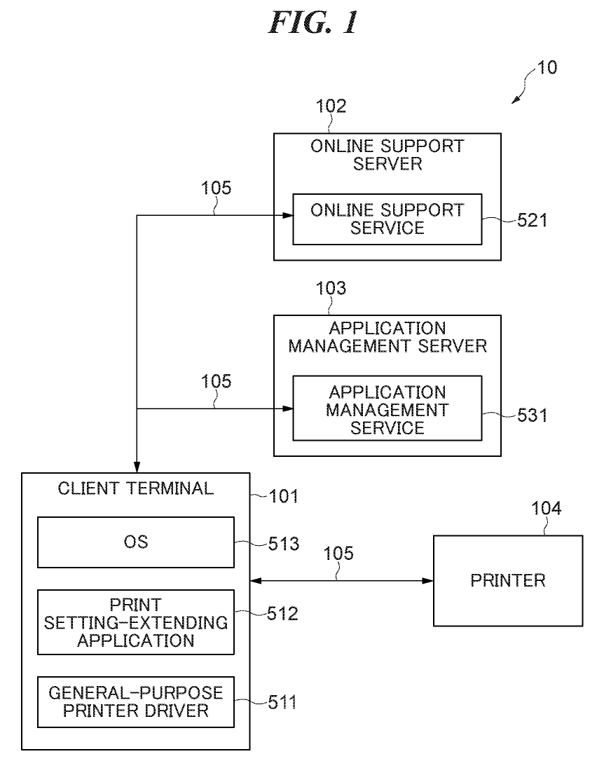

FIG. 1 is a block diagram showing a hardware configuration of a printing system. As shown in FIG. 1, the printing system, denoted by reference numeral 10, includes a client terminal 101, an online support server 102, an application management server 103, and a printer 104, and these are communicably connected to each other via a network 105. Note that although one client terminal 101 and one printer 104 are arranged in the configuration shown in FIG. 1, this is not limitative, but the client PC 102 and the printer 104 can each be provided in plurality. Further, each of the application management server 103 and the online support server 102 can be a server system formed by a plurality of information processing apparatuses. With this, it is possible to distribute processing loads in each server. Further, the application management server 103 and the online support server 102 can be virtually formed within one information processing apparatus. The network 105 can be a wide area network (WAN), such as the Internet, or an intracompany local area network (LAN).

The client terminal 101 is formed by an information processing apparatus, such as a desktop-type or laptop-type personal computer, a tablet terminal, or a smartphone. The client terminal 101 has a general-purpose printer driver (standard driver) 511, a print setting-extending application (application program) 512, and an OS (operating system) 513. The general-purpose printer driver 511 is a program provided from the provider of the OS 513 and installed in the client terminal 101. The general-purpose printer driver 511 is capable of generating print data to be printed by the printer 104. The print setting-extending application 512 is a program supporting the general-purpose printer driver 511 and is installed similarly to the general-purpose printer driver 511. The printer 104 is an image forming apparatus (image forming system), such as a multi-function peripheral (MFP) and a single function printer (SFP). The printer 104 is capable of converting print data received e.g. from the client terminal 101 via the network 105 to image data, and printing the image data on a recording medium, such as a print sheet. The application management server 103 holds and manages a variety of application programs, such as an application management service 531. The application management server 103 receives identification information and a download request of an application program from the client terminal 101. Then, the application management server 103 transmits the application identified based on this identification information to the client terminal 101. The online support server 102 is a server apparatus that provides an online support service 521. The online support service 521 can provide an extension setup information file, in which information for extending the function of the client terminal 101 is described, to the client terminal 101.

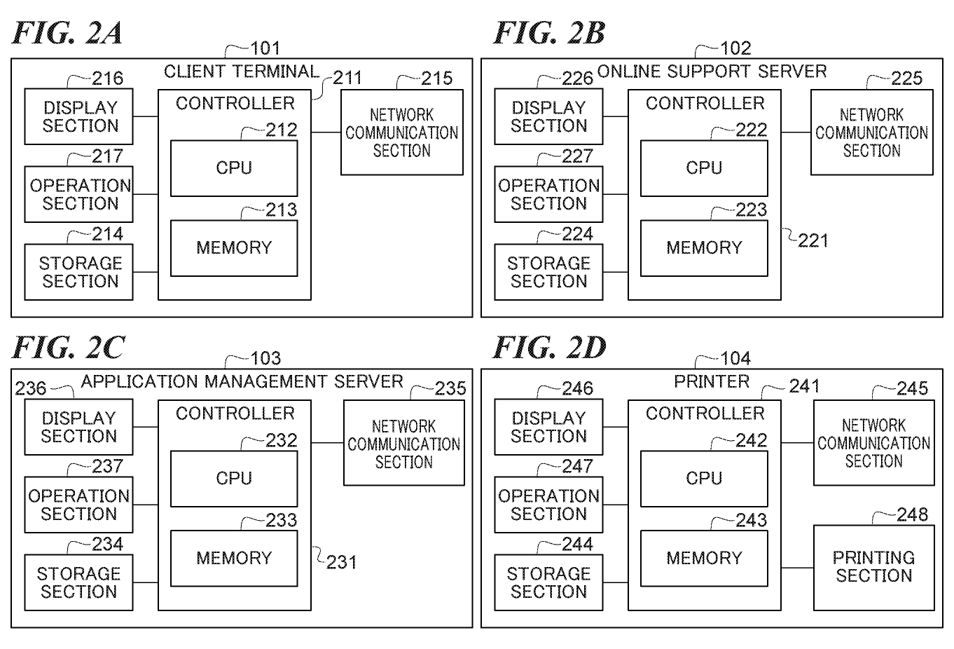

FIGS. 2A to 2D are block diagrams showing respective hardware configurations of the apparatuses included in the printing system 10. FIG. 2A is a block diagram showing the hardware configuration of the client terminal 101. FIG. 2B is a block diagram showing the hardware configuration of the online support server 102. FIG. 2C is a block diagram showing the hardware configuration of the application management server 103. FIG. 2D is a block diagram showing the hardware configuration of the printer 104. As shown in FIG. 2A, the client terminal 101 includes a controller 211, a storage section 214, a display section 216, a network communication section 215, and an operation section 217. The storage section 214 is implemented by a nonvolatile storage device, such as a hard disk drive (HDD) or a solid state drive (SSD). In the storage section 214, digital data can be stored and is rewritable. Note that the storage section 214 stores the general-purpose printer driver 511, the print setting-extending application 512, and the OS 513. The controller 211 is comprised of a central processing unit (CPU) (computer) 212 and a memory 213, and controls the overall operation of the client terminal 101. The CPU 212 loads the programs stored in the storage section 214 into the memory 213 and executes the loaded programs. Note that the print setting-extending application 512 can cause the CPU 212 to execute steps (control method), described hereinafter. The memory 213 is used as a main storage memory for the CPU 212, and is further used as a work area and a temporary storage area for loading a variety of programs.

The network communication section 215 is a device that performs communication, i.e. inputs and outputs digital data, between the same and the online support server 102, the application management server 103, and the printer 104 via the network 105. The display section 216 is formed e.g. by a liquid crystal display and can display a variety of information to a user using the client terminal 101. The operation section 217 is comprised of e.g. a keyboard and a mouse and can receive an input from a user. Note that the client terminal 101 can have a touch panel. The touch panel has both functions of the display section 216 and the operation section 217.

As shown in FIG. 2B, the online support server 102 includes a controller 221, a storage section 224, a network communication section 225, a display section 226, and an operation section 227. The storage section 224 is implemented by a nonvolatile storage device, such as an HDD and an SSD. In the storage section 224, the extension setup information file is stored. The extension setup information file is a file in which information for extending the function of the client terminal 101 is described. The controller 221 is comprised of a CPU 222 and a memory 223 and controls the overall operation of the online support server 102. The CPU 222 loads programs stored in the storage section 224 into the memory 223 and executes the loaded programs. The network communication section 225 is a device that performs communication between the same and the client terminal 101 via the network 105. With this, the online support server 102 can receive a request for acquiring a file stored in the storage section 224, or transmit a file stored in the storage section 224 to the client terminal 101. The display section 226 and the operation section 227 are the same as the display section 216 and the operation section 217 of the client terminal 101.

As shown in FIG. 2C, the application management server 103 includes a controller 231, a storage section 234, a network communication section 235, a display section 236, and an operation section 237. The controller 231 is comprised of a CPU 232 and a memory 233. These hardware items included in the application management server 103 are the same as the hardware included in the client terminal 101.

As shown in FIG. 2D, the printer 104 includes a controller 241, a storage section 244, a network communication section 245, a display section 246, an operation section 247, and a printing section 248. The controller 241 is comprised of a CPU 242 and a memory 243. The controller 241, the storage section 244, the network communication section 245, the display section 246, and the operation section 247, included in the printer 104, are the same as the controller 211, the storage section 214, the network communication section 215, the display section 216, and the operation section 217, included in the client terminal 101. The printing section 248 has an image forming section that performs printing on a print sheet to form an image on the print sheet. The image forming method is not particularly limited, but, for example, the electrophotographic method, the inkjet method, or the like can be used.

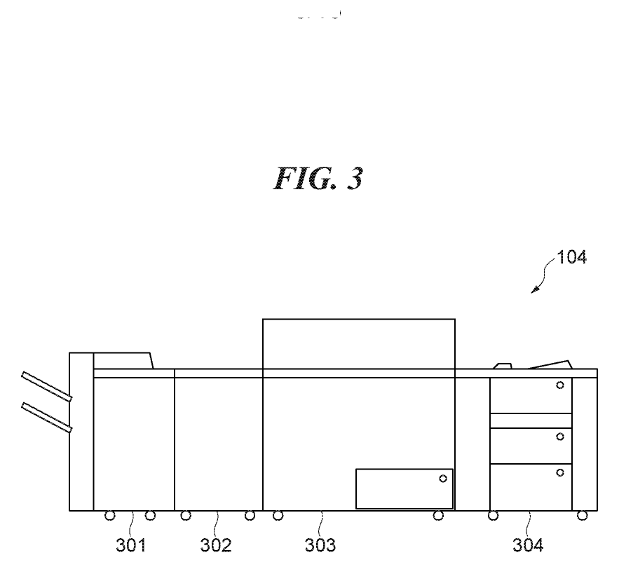

FIG. 3 is an appearance view of the printer. As shown in FIG. 3, the printer 104 has a finishing unit 301, a punching unit 302, a main unit sheet feeding unit 303, and an optional sheet feeding unit 304. The main unit sheet feeding unit 303 includes accommodating sections, such as cassettes for accommodating print sheets (such as plain paper) and a tray, and supplies a print sheet from one of the accommodating sections. The optional sheet feeding unit 304 has an accommodating section including a cassette for accommodating print sheets (such as glossy paper) different from the print sheets accommodated in the main unit sheet feeding unit 303 and a tray, and supplies a print sheet from the accommodating section. The punching unit 302 has a punched hole-forming function which can form sets of punched holes (hereinafter referred to as the “punched hole sets”) each formed by a plurality of punched holes at a plurality of positions of a printed sheet on which an image has been formed, i.e., a printed matter. Note that in the present embodiment, the punching unit 302 has the punched hole-forming function for forming a punched hole set (punched hole group) formed by two punched holes (double punching) at a plurality of positions. Further, in the present embodiment, the punching unit 302 is described as one included in the printing section 248. The finishing unit 301 performs, for example, stapling processing and bookbinding processing on a printed matter.

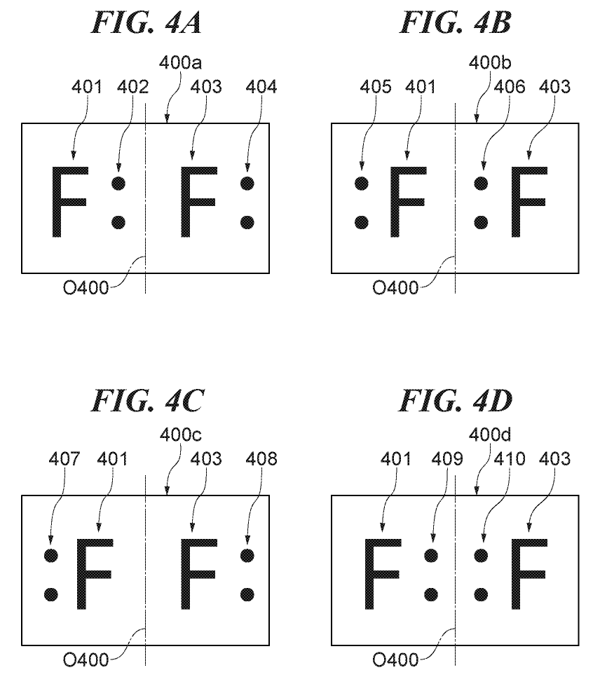

FIGS. 4A to 4D are diagrams each showing a printed matter formed with a punched hole set. FIG. 4A is a diagram showing a first example of the printed matter formed with a punched hole set. FIG. 4B is a diagram showing a second example of the printed matter formed with a punched hole set. FIG. 4C is a diagram showing a third example of the printed matter formed with a punched hole set. FIG. 4D is a diagram showing a fourth example of a printed matter formed with a punched hole set. A printed matter 400a shown in FIG. 4A is in a state in which an image 401 has been printed on the left side of a center line O400, which passes through the center of an A4-size print sheet and is parallel to a width direction orthogonal to a longitudinal direction, and an image 403 has been formed on the right side of the center line O400. This state is the same in a printed matter 400b shown in FIG. 4B, a printed matter 400c shown in FIG. 4C, and a printed matter 400d shown in FIG. 4D. In the printed matter 400a, a punched hole set 402 is formed on a right-side part of the image 401, and a punched hole set 404 is formed on a right-side part of the image 403. In the printed matter 400b, a punched hole set 405 is formed on a left-side part of the image 401, and a punched hole set 406 is formed on a left-side part of the image 403. In the printed matter 400c, a punched hole set 407 is formed on the left-side part of the image 401, and a punched hole set 408 is formed on the right-side part of the image 403. In the printed matter 400d, a punched hole set 409 is formed on the right-side part of the image 401, and a punched hole set 410 is formed on the left-side part of the image 403.

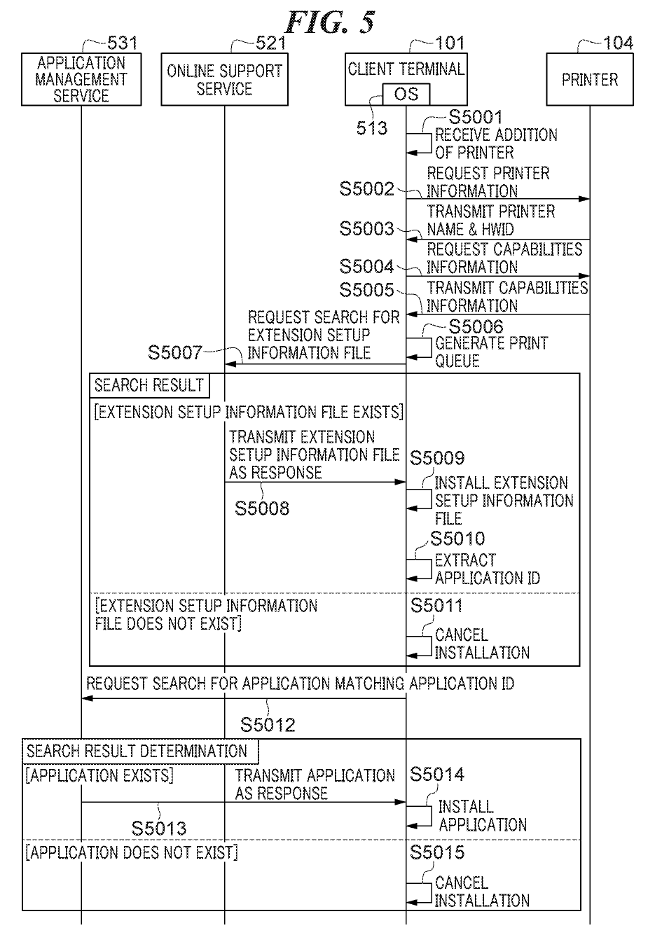

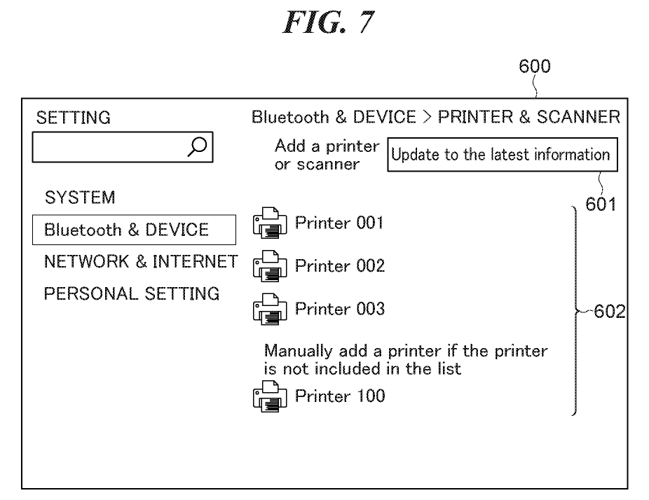

FIG. 5 is a sequence diagram showing a process executed between the application management service 531, the online support service 521, the OS 513 of the client terminal 101, and the printer 104. First, installation of the general-purpose printer driver 511 will be described with reference to FIG. 5. The general-purpose printer driver 511 is a program operating based on the Internet Printing Protocol (IPP). Further, the general-purpose printer driver 511 is a program which cannot receive a double punch setting 705 (punched-hole setting), described hereinafter. Referring to FIG. 5, in a step S5001, the OS 513 of the client terminal 101 receives an operation of adding a printer. This addition operation is a printer setup operation and is performed on a setup screen 600 (see FIG. 7). FIG. 7 is a diagram showing an example of the setup screen 600 displayed on the display section 216 of the client terminal 101. The setup screen 600 includes an object 601 and an area 602. By pressing the object 601, a search instruction for searching for the printer 104 is input to the OS 513.

In a step S5002, the OS 513 of the client terminal 101 searches for a printer which has already been registered in the client terminal 101 and a printer connected via the network 105. Then, the OS 513 transmits a printer information acquisition request to each printer. As the printer which has already been registered in the client terminal 101, the printer 104 exists. Further, the search for a printer connected via the network 105 is a device search using e.g. mDNS or Bonjour.

In a step S5003, the printer (e.g. the printer 104) searched for in the step S5002 transmits printer information to the client terminal 101. This printer information includes, for example, a printer name and a hardware ID (HWID) of this printer. This enables the OS 513 of the client terminal 101 to acquire the printer information transmitted from each printer. Then, the OS 513 displays a printer list in the area 602 of the setup screen 600 based on each printer information. In the area 602, as an example of the printer list, “Printer 001, “Printer 002”, “Printer 003”, “Printer 100”, “Manually add a printer if the printer is not included in the list” are displayed. The printers indicated by “Printer 001” to “Printer 003” are printers which can be added. The printer indicated by “Printer 100” is a printer which has already been registered in the client terminal 101. The user can select, out of the printers indicated by “Printer 001” to “Printer 100”, a printer corresponding to a printer desired to register in the client terminal 101. Here, it is assumed that “Printer 100” is selected. The printer indicated by “Printer 100” is the printer 104. Note that in a case where a printer other than the printers indicated by “Printer 001” to “Printer 100” is to be added, “Manually add a printer if the printer is not included in the list” is selected.

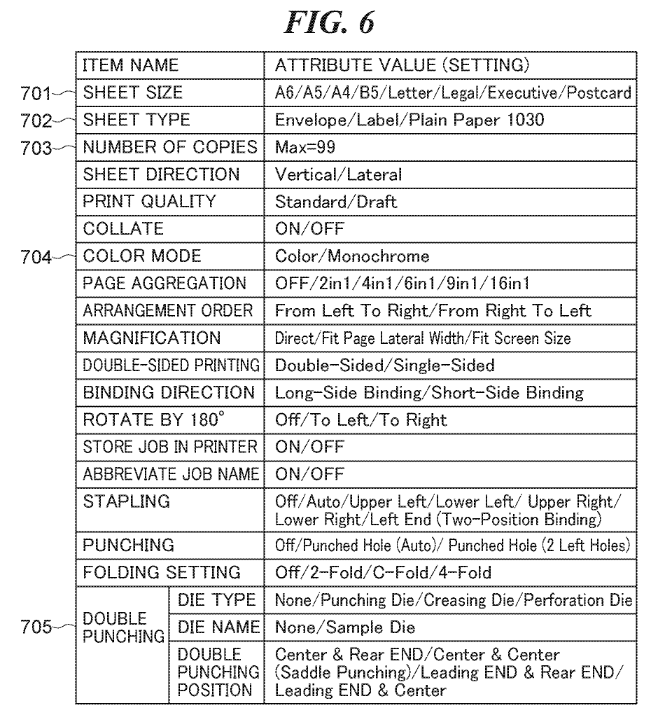

In a step S5004, the OS 513 of the client terminal 101 inquires (requests) the printer 104 of capabilities information. FIG. 6 is a diagram showing an example of the capabilities information of the printer. As shown in FIG. 6, the capabilities information of the printer is information related to the capabilities which can be executed by the printer 104 and is comprised of item names and attribute values. The item name corresponds to each setting item of print settings. The item names include ones related to a sheet, such as a sheet size 701 and a sheet type 702, ones related to printing, such as the number of copies 703 and a color mode 704, ones related to the punched hole-forming function, such as the double punch setting 705, and so forth. In the printer 104, not only the item names and the attribute values, defined by the IPP as the industry standard specification, but also item names and attribute values, originally defined by the printer vendor, are stored. Note that the double punch setting 705 is an item for forming punched hole sets (punched hole groups) each formed by two punched holes, at a plurality of positions. The attribute values correspond to a setting, an option, and a value range, which can be set for each setting item. In the present embodiment, the capabilities information is transmitted to the client terminal 101 according to the IPP as the communication protocol. The printer 104 registers the capabilities information by using a command prepared by the client terminal 101.

In a step S5005, the printer 104 transmits the capabilities information in response to the inquiry about the capabilities information, which is received in the step S5004. With this, the OS 513 of the client terminal 101 can acquire the capabilities information from the printer 104 (acquisition step) before a display control step, described hereinafter. The OS 513 starts installation of the general-purpose printer driver 511 based on the capabilities information. Note that the capabilities information transmitted from the printer 104 includes attribute values associated with the items designated by the client terminal 101and default values. The attribute values are all attribute values registered in the printer 104 regardless of whether or not each attribute value is an attribute value defined as a standard. The default values are values to be initially displayed for setting when the client terminal 101 displays a print setting screen. Note that in a case where the attribute values associated with the items designated by the client terminal 101 and the default values have not been stored in the printer 104, transmission of the capabilities information to the client terminal 101 is suspended. Further, the timing of transmitting the capabilities information can be e.g. a timing at which the capabilities information is changed in the printer 104, or a timing at which update of the capabilities information in the printer 104 is instructed.

In a step S5006, the OS 513 of the client terminal 101 generates a print queue of the general-purpose printer driver 511 packaged in the OS 513 and including device capabilities information. The device capabilities information refers to definition information necessary for the printer driver to generate capabilities information for making print settings. As the device capabilities information, there is information described in XML, such as Print Device Capabilities.

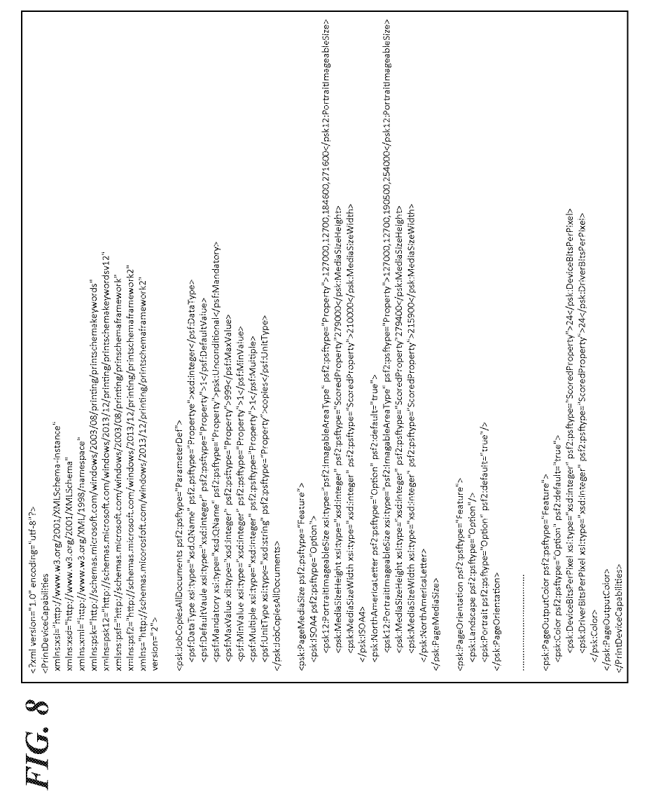

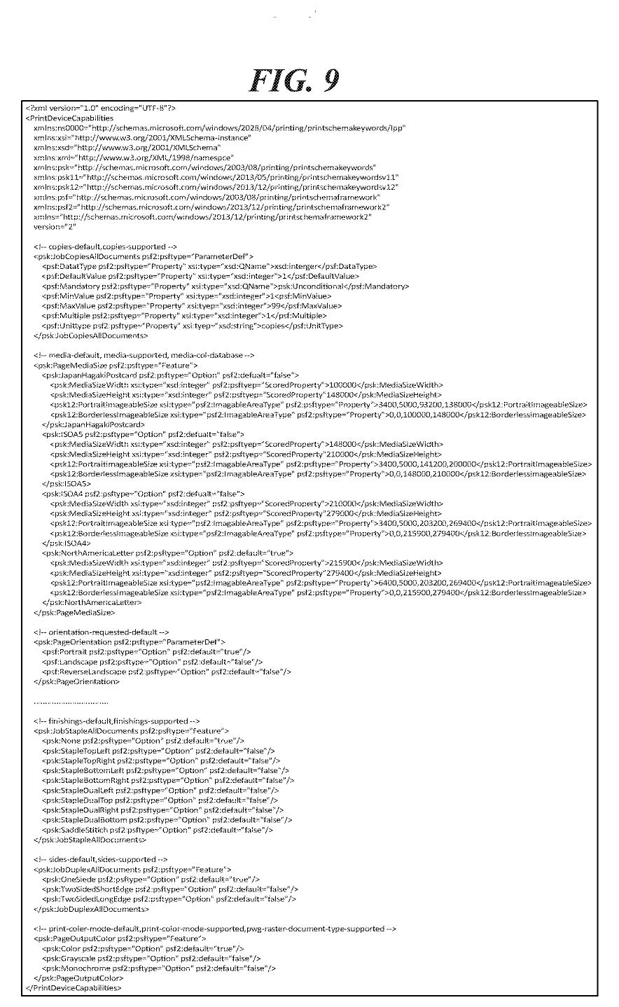

FIG. 8 is a diagram showing an example of the device capabilities information in an initial state, a file of which is packaged in the OS. As shown in FIG. 8, the device capabilities information includes, for example, “Feature” and “Option”. The information “Feature” indicates that “Page Media Size” representing a sheet size is the setting item. “Option” indicates an option associated with “Page Media Size”. Further, in the device capabilities information in the initial state, there are two options of “A4” and “LETTER” as the sheet sizes. This device capabilities information is stored, when a print queue is generated, in a state associated with the generated print queue. Note that the device capabilities information in the initial state is specified as fixed values regardless of the printer information. Then, the OS 513 updates the device capabilities information as a component of the general-purpose printer driver 511 with the device capabilities information in the initial state. FIG. 9 is a diagram showing an example of the updated device capabilities information. As shown in FIG. 9, for example, as the sheet size which can be printed by the printer 104, “Option” other than “A4” and “LETTER” is added to “Page Media Size” representing the sheet size.

As described above, first, the client terminal 101 registers the general-purpose printer driver 511 and the device capabilities information packaged in the OS 513 in the print queue in a state associated with each other. Then, the device capabilities information associated with the print queue is updated with the capabilities information acquired from the printer 104. At this time, the OS 513 updates the device capabilities information only with the attribute values, defined by the industry standard specification, out of the capabilities information acquired from the printer 104. Therefore, even if a vendor-unique attribute value is acquired as a sheet type when the capabilities information is acquired, the vendor-unique attribute value is not added to the device capabilities information. With this, it is possible to make a print setting which cannot be made based on the device capabilities information packaged in the OS 513.

By performing the above-described process, installation of the general-purpose printer driver 513 is completed. With this, it is possible to transmit print data to the print queue generated by the client terminal 101 for the printer 104.

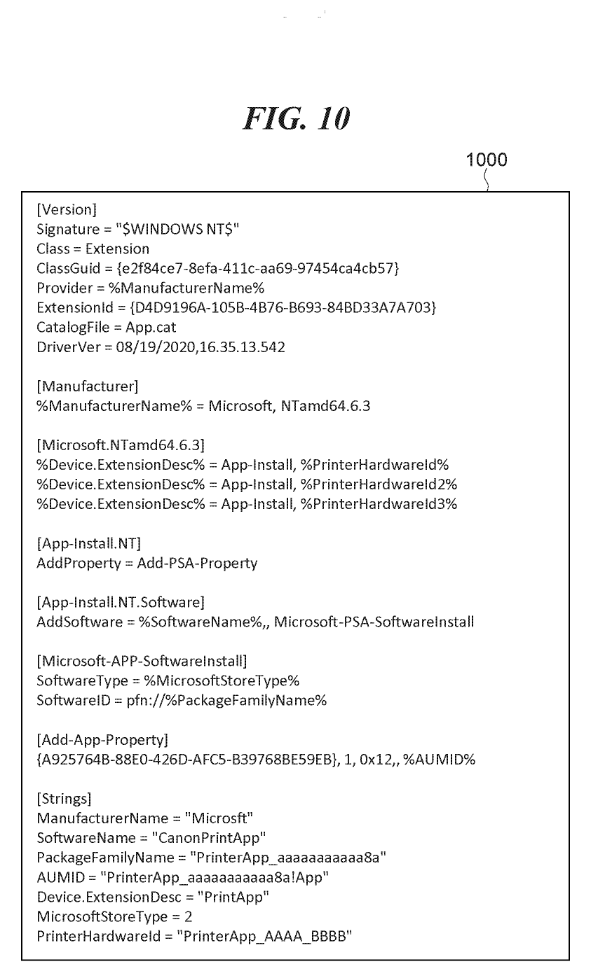

Next, installation of the print setting-extending application 512 will be described. First, the OS 513 performs processing for attaching identification additional information to the device identification information. This processing is necessary for requesting acquisition of an extension setup information file 1000 (see FIG. 10) to the online support server 102. FIG. 10 is a diagram showing an example of the extension setup information file. The extension setup information file 1000 shown in FIG. 10 is a file generated by the vendor of the printer 104 and registered in the online support service 521. The extension setup information file 1000 is formed e.g. by character strings different from the normal device identification information, numbers, symbols, and so forth. In the present embodiment, to distinguish the print setting-extending application 512 from an application of another device, identification additional information “PrinterApp_” indicating an application compatible with the printer 104 is attached to the device identification information by the OS 513. Note that the identification additional information is not limited to “PrinterApp_”. For example, in a case where the device identification information of the printer 104 is “device 001”, the device identification information after executing the identification additional information attachment processing is changed to “PrinterApp_device001”. Further, in the extension setup information file 1000, an application identifier for identifying the print setting-extending application used for setting print data to be transmitted to the printer 104 is described. For example, “PackageFamilyName” indicates the identification information of the print setting-extending application 512. A character string “PrinterHardwareId” indicates a character string formed by adding the identification additional information to the identification information of the printer 104.

As shown in FIG. 5, in a step S5007, the OS 513 of the client terminal 101 transmits a request for searching for the extension setup information file 1000 to the online support service 521. With this, “PrinterApp_device001” is notified to the online support service 521. In a case where the search request is received, the online support service 521 identifies an extension setup information file in which the device identification information including the identification additional information designated by this request matches “PackageFamilyName”.

In a step S5008, the online support service 521 performs search processing in response to the search request received in the step S5007. Then, as a result of this search, in a case where the extension setup information file 1000 including identification information of the target device exits, the online support service 521 transmits the extension setup information file 1000 to the OS 513 as a response.

In a step S5009, the OS 513 of the client terminal 101 installs extension setup information included in the extension setup information file 1000 received as the response in the step S5008, in a state associated with the print queue generated in the step S5006. Further, the contents of the extension setup information file 1000 are written into a registry of the OS 513.

In a step S5010, the OS 513 of the client terminal 101 extracts an application ID from the extension setup information installed in the step S5009. The “application ID” is an identifier specified in “PackageFamilyName” in the extension setup information file 1000.

Note that there is a case where, as a result of the search in the step S5008, the extension setup information file 1000 including the identification information of the target device does not exist. In this case, in a step S5011, the OS 513 cancels the installation processing. Cancelation of the installation is also executed in a case where the extension setup information file 1000 has not been received within a predetermined time period after the search request is executed in the step S5007 or in a case where an error notification is received from the online support service 521.

Next, a process performed in a case where acquisition of the extension setup information file 1000 is successful, and at the same time, extraction of the application ID is successful in the step S5010 will be described. As shown in FIG. 5, in a step S5012, the OS 513 requests the application management service 531 to search for an application having the same application ID as the application ID extracted in the step S5010. The application management service 531 stores an application operating in the client terminal 101 and an application ID which is the identifier of this application, in a state associated with each other. The application and the application ID are registered in the application management service 531 by the vendor providing the printer 104.

In a step S5013, in a case where a print setting-extending application which matches the application ID exists, the application management service 531 transmits this print setting-extending application (the print setting-extending application 512 in this example) to the client terminal 101 as a response.

In a step S5014, the OS 513 installs the print setting-extending application 512 transmitted as the response in the step S5013 in a state associated with the print queue on the side of the client terminal 101. The OS 513 stores the application ID in the registry as the information on the print queue. Further, the print setting-extending application 512 makes a setting of transmitting an event notification, for the OS 513, when the print queue associated with the application is set on the print setting screen. After the installation, the print setting-extending application 512 is started, when the client terminal 101 is powered on and the OS 513 is started. After being started, the print setting-extending application 512 operates as the background task

In a step S5015, in a case where a print setting-extending application which matches the application ID is does not exist, the OS 513 cancels the installation processing. In this case, the print queue and the general-purpose printer driver 511 are installed in a state associated with each other.

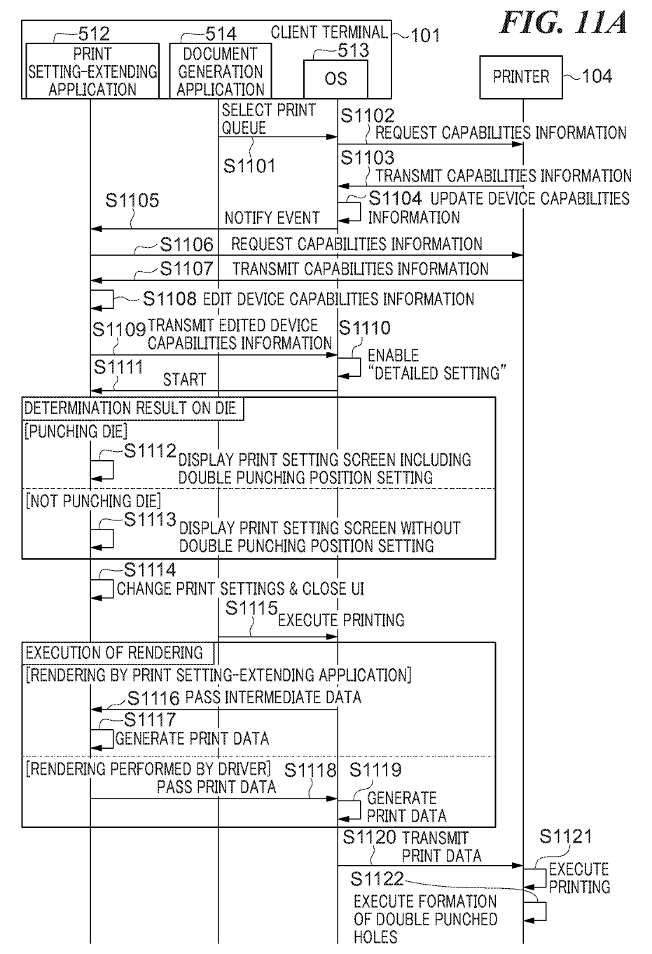

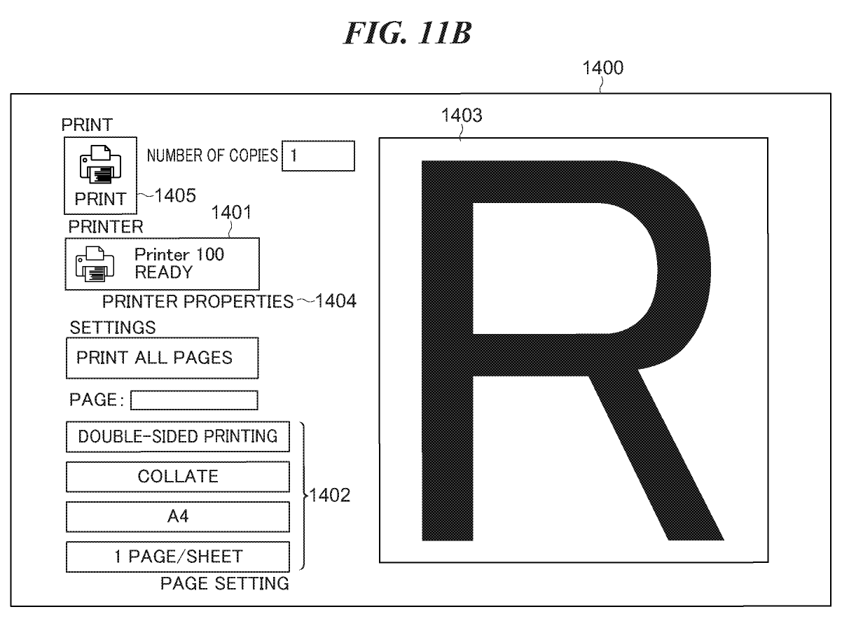

FIG. 11A is a sequence diagram showing a process executed between the print setting-extending application 512, a document generation application 514, the OS 513, and the printer 104. Note that the document generation application 514 is e.g. an application for creating document data, an application for creating a presentation material, or an application for displaying a photo and image data, and is installed into the client terminal 101 in advance. Referring to FIG. 11A, in a step S1101, the OS 513 of the client terminal 101 selects a print queue associated with the printer 104 set as the default printer (step S1101). The operation of selecting a print queue is performed on a print setting screen 1400 (see FIG. 11B). FIG. 11B shows the print setting screen 1400 displayed on the display section 216 of the client terminal 101, on which the operation of selecting a print queue can be performed. The print setting screen 1400 shown in FIG. 11B is displayed by the document generation application 514 or the OS 513 as a print setting initial screen. The print setting screen 1400 includes an object 1401, an object 1402, a print preview image 1403, an object 1404, and an object 1405. With the object 1401, the user can select a print queue. Here, it is assumed that the printer 104 as “Printer 100” is selected as the default printer. With the object 1402, the user can set a variety of print settings. The print preview image 1403 is an image which visualizes print data to be printed. With the object 1404, the user can set detailed conditions for printing. With the object 1405, the user can instruct the start of printing.

In a step S1102, similar to the step S5004, the OS 513 requests the capabilities information of the printer 104 with respect to the print queue selected in the step S1101. This request is performed by using a standard protocol command defined by the IPP, such as Get-print-Attributes. In this case, acquisition of the capabilities information determined by the OS 513 in a list form is requested.

In a step S1103, the printer 104 transmits the capabilities information requested in the step S1102 to the OS 513. For example, let it be assumed that attributes of the media size are designated by Get-print-Attributes (IPP). In this case, if the printer 104 holds the attributes of the media size, the printer 104 transmits information on values associated with the attributes (such as “A4”, “B5”, and “Letter”). Further, if no attributes designated by Get-print-Attributes exist in the printer 104, a response of the values associated with the attribute is not transmitted.

In a step S1104, the OS 513 adds the capabilities information transmitted in the step S1103 to the device capabilities information to update the device capabilities information. Note that in the update of the device capabilities information, only attribute values defined by the industry standard specification are updated.

In a step S1105, the OS 513 notifies an event and an API used for editing the device capabilities information to the print setting-extending application 512. Note that the event notification timing is registered when the print setting-extending application 512 is installed into the client terminal 101.

In a step S1106, in a case where the event notified in the step S1105 is received, the print setting-extending application 512 requests to the printer 104 the capabilities information of the setting items including printer vendor-unique setting items and attribute values unique to the printer vendor. Similar to the step S1102, this request is performed by using an industry standard protocol command.

In a step S1107, similar to the step S5005, the printer 104 transmits the capabilities information to the print setting-extending application 512 in response to the request received in the step S1106.

In a step S1108, the print setting-extending application 512 acquires the capabilities information transmitted in the step S1107. The print setting-extending application 512 edits the device capabilities information managed by the OS 513 via a configuration information object. The configuration information object refers to a data group collecting data necessary to edit the device capabilities information. The print setting-extending application 512 cannot directly edit the device capabilities information held by the OS 513. Therefore, the print setting-extending application 512 edits (changes) the device capabilities information held by the OS 513 by using the configuration information object. The capabilities information includes, for example, information related to “die type”, “die name”, “double-punching positions”, and so forth, which are necessary for the double punch setting 705 (punched hole-forming function). The print setting-extending application 512 edits the device capabilities information by converting these information items, such as “die type”, and adding the resulting information to the configuration information object.

In a step S1109, the print setting-extending application 512 transmits the device capabilities information edited in the step S1108 to the OS 513. With this, the OS 513 can store the device capabilities information in a state associated with the print queue.

In a step S1110, the OS 513 changes the object 1404 from a grayed-out state to a state released from the grayed-out state based on the device capabilities information edited in the step S1108. With this, the operation to be performed with respect to the object 1404 on the print setting screen 1400 is enabled, and therefore, it is possible to set detailed conditions (detailed settings) for printing.

In a step S1111, in a case where the object 1404 on the print setting screen 1400 is operated, the OS 513 starts the print setting-extending application 512.

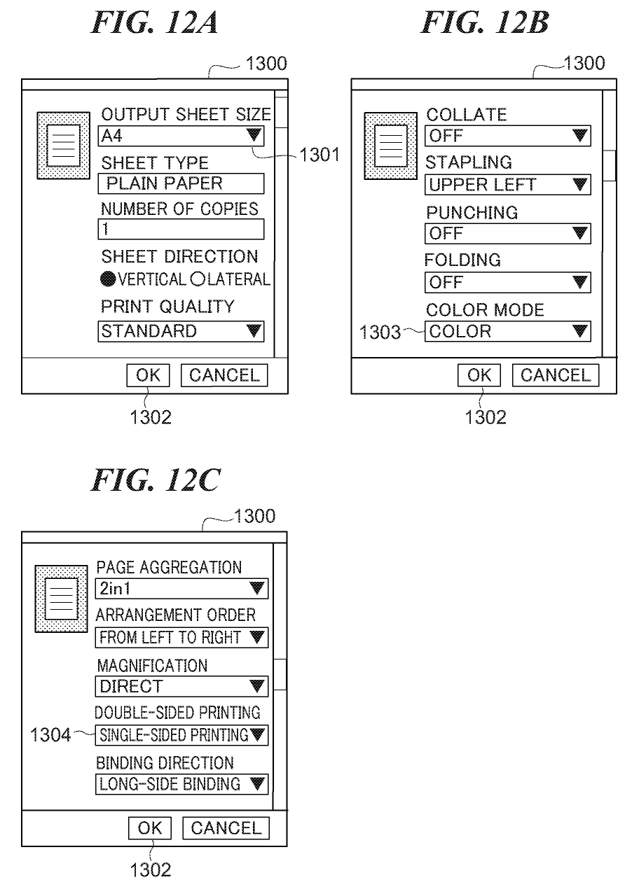

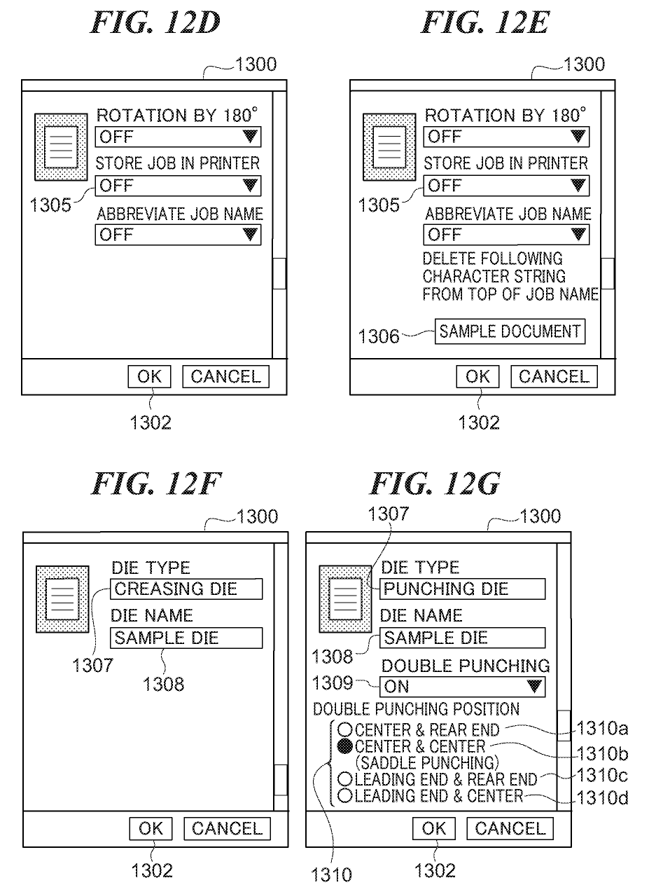

In a step S1112, the print setting-extending application 512 displays a detailed setting screen (setting reception screen) 1300 shown in FIG. 12 on the display section 216 based on the device capabilities information edited in the step S1108 (display control step). Note that the detailed setting screen 1300 is displayed regardless of a type of the document generation application 514. FIGS. 12A to 12G are diagrams each showing a detailed setting screen displayed on the display section 216 of the client terminal 101, on which detailed conditions for printing can be set. FIGS. 12A to 12G show a transition state of the detailed setting screen 1300 shifted by operating a scroll bar. In the state shown in FIG. 12A, an object 1301, an object 1302, and so forth are displayed on the detailed setting screen 1300. With the object 1301, the user can select a sheet size. This object 1301 is generated based on “psk: PageMediaSize” in the device capabilities information shown in FIG. 9. Further, an option “A4” of the object 1301 is generated based on “psk: IOSA4” in the device capabilities information shown in FIG. 9. With the object 1302, the user can determine the detailed conditions set on the detailed setting screen 1300. Note that the object 1302 is displayed regardless of the operation of the scroll bar.

In the state shown in FIG. 12B, an object 1303 and the like are displayed on the detailed setting screen 1300. With the object 1303, the user can select a color mode or a monochrome mode. In the state shown in FIG. 12C, an object 1304 and the like are displayed on the detailed setting screen 1300. With the object 1304, the user can select double-sided printing or single-sided printing. In the state shown in FIG. 12D, an object 1305 and the like are displayed on the detailed setting screen 1300. With the object 1305, the user can select whether or not to store a print job in the printer. The state shown in FIG. 12E is a variation of the state shown in FIG. 12D. In the state shown in FIG. 12E, not only the object 1305 and the like, but also an object 1306 is displayed on the detailed setting screen 1300. With the object 1306, the user can instruct deletion of a print job name.

In the state shown in FIG. 12F, an object 1307 and an object 1308 are displayed on the detailed setting screen 1300. The object 1307 is a type selection section for selecting a type of a working tool used for executing the punched hole-forming function, i.e. a type of the die. The object 1308 is a name selection section for selecting the name of a die. The state shown in FIG. 12G is a variation of the state shown in FIG. 12F. In the state shown in FIG. 12G, not only the object 1307 and the object 1308, but also an object 1309 and an object 1310 are displayed on the detailed setting screen 1300. The object 1309 is an execution selection section for selecting whether or not to execute double punching. The object 1310 is a position selection section for selecting an execution position of double punching (positions where each set of punched holes are formed). In a case where an option 1310a of the object 1310 is selected, the printed matter shown in FIG. 4A is obtained. In a case where an option 1310b of the object 1310 is selected, the printed matter shown in FIG. 4D is obtained. In a case where an option 1310c of the object 1310 is selected, the printed matter shown in FIG. 4C is obtained. In a case where an option 1310d of the object 1310 is selected, the printed matter shown in FIG. 4B is obtained. Thus, the detailed setting screen 1300 in the state shown in FIG. 12G has a function as a reception screen for receiving the punched-hole setting for causing the printer 104 to execute the punched hole-forming function. Note that although the detailed setting screen 1300 in the state shown in FIG. 12G includes the objects 1307 to 1310 as the punched-hole setting, this is not limitative, but at least one of these objects is required to be included.

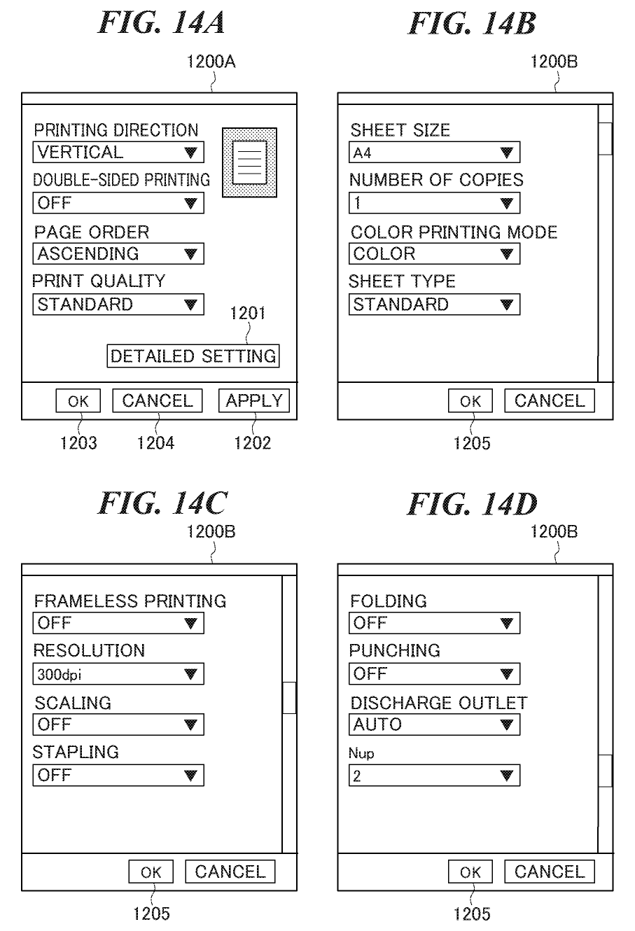

The above-described detailed setting screen 1300 is displayed in a case where the information which enables the printer 104 to execute the punched hole-forming function is included in the capabilities information of the printer 104, which is acquired in the acquisition step. On the other hand, in a case where the information which enables the printer 104 to execute the punched hole-forming function is not included in the capabilities information of the printer 104, the display of the detailed setting screen 1300 is inhibited. At this time, a detailed setting screen 1200B (see FIGS. 14B to 14D) on which the punched-hole setting is omitted is displayed in place of the detailed setting screen 1300.

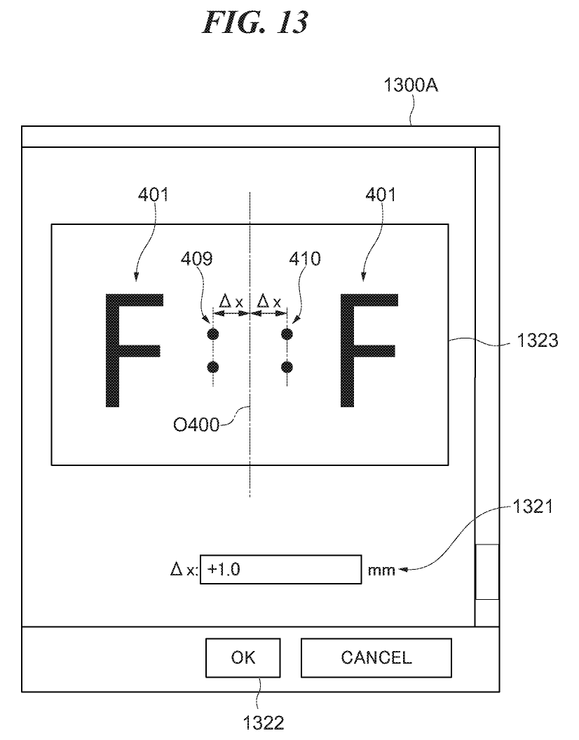

FIG. 13 is a diagram showing a variation of the detailed setting screen displayed on the display section 216 of the client terminal 101, on which detailed conditions for printing can be set. A detailed setting screen 1300A shown in FIG. 13 is displayed in a case where one of the options 1310a to 1310d is selected in the object 1310. The detailed setting screen 1300A includes an object 1321, an object 1322, and a preview image 1323. The object 1321 is a fine adjustment section for finely adjusting positions where the punched-hole sets are to be formed by double punching, and the user can input a fine adjustment amount Δx as a numerical value. With the object 1322, the user can determine detailed conditions set on the detailed setting screen 1300A. The preview image 1323 is a preview image of image data. On this preview image 1323, the positions where the double punched holes are formed are visualized. For example, in a case where the punched-hole set 409 and the punched-hole set 410 on the respective images 401 overlap, by finely adjusting the positions where the double punched holes are formed, by using the object 1321, it is possible to eliminate the overlapping state. In the case shown in FIG. 13, if the fine adjustment amount Δx is set to a positive numerical value, the positions of the punched-hole set 409 and the punched-hole set 410 are adjusted in a direction away from the center line O400 by |Δx|. Further, if the fine adjustment amount Δx is set to a negative numerical value, the positions of the punched-hole set 409 and the punched-hole set 410 are adjusted in a direction approaching to the center line O400 by |Δx|.

FIG. 14A and FIGS. 14B to 14D are a diagram showing a print setting screen, and diagrams each showing a detailed setting screen displayed on the display section 216 of the client terminal 101, on which detailed conditions for printing can be set, respectively. FIG. 14A shows a print setting screen 1200A. FIGS. 14B to 14D each show the detailed setting screen 1200B. Note that FIGS. 14B to 14D each show a state in which the detailed setting screen 1200B is shifted by operating a scroll bar. Further, differently from the detailed setting screen 1300, both of the print setting screen 1200A and the detailed setting screen 1200B are screens from which the punched-hole setting in double punching is omitted. The print setting screen 1200A includes objects 1201 to 1204. By pressing the object 1201, the detailed setting screen 1200B is displayed. By pressing the object 1202 or the object 1203, the setting state on the detailed setting screen 1200B is stored. By pressing the object 1204, the setting state on the detailed setting screen 1200B is canceled. The detailed setting screen 1200B is a screen for setting the print conditions and the like in detail. This detailed setting screen 1200B includes an object 1205. By pressing the object 1205, the setting state on the detailed setting screen 1200B is stored, and the detailed setting screen 1200B is closed and returns to the print setting screen 1200A.

As shown in FIG. 11A, in a step S1113, the print setting-extending application 512 displays the detailed setting screen 1300 in the state shown in FIG. 12E on the display section 216 based on the device capabilities information edited in the step S1108. This detailed setting screen 1300 is displayed in a case where the type of the die attached to the punching unit 302 is not a punching die.

In a step S1114, the print setting-extending application 512 closes the detailed setting screen 1300 after transmitting the print setting information to the OS 513. Further, after the detailed setting screen 1300 is closed, the print setting screen 1400 shown in FIG. 11B is displayed. This print setting screen 1400 is a screen including settings made by the print setting-extending application 512.

In a step S1115, in a case where the object 1405 on the print setting screen 1400 is pressed, the document generation application 514 transmits a print execution instruction to the OS 513.

In a step S1116, the OS 513 receives the print execution instruction transmitted in the step S1115 and generates intermediate data based on this print execution instruction. The intermediate data refers to data generated before converted to print data, such as PDL (PDF file), and, for example, corresponds to XPS data. The OS 513 transmits this intermediate data and the print setting information transmitted to the OS 513 in the step S1114 to the print setting-extending application 512.

In a step S1117, the print setting-extending application 512 receives the intermediate data and the print setting information, transmitted in the step S1116. The print setting-extending application 512 generates print data based on the intermediate data and generates print capabilities information based on the print setting information. The print data is e.g. PDL data. The print capabilities information refers to information in which, for example, the print setting information is described in attribute values defined by the IPP.

In a step S1118, the print setting-extending application 512 transmits the print data and the print capabilities information, generated in the step S1117, to the print queue of the OS 513.

The above-described steps S1116 to S1118 are processing operations performed in a case where the print setting-extending application 512 associated with the print queue has been installed in the client terminal 101. On the other hand, in a case where the print setting-extending application 512 has not been installed in the client terminal 101, in a step S1119, the OS 513 generates XPS data. Further, the OS 513 generates the print data and the print capabilities information by editing the page layout and converting the XPS data to a predetermined format. This predetermined format refers to PDF, PWG-Raster, or the like.

In a step S1120, the OS 513 transmits the print data and the print capabilities information to the printer 104 via the print queue.

In a step S1121, the printer 104 receives the print data and the print capabilities information, transmitted in the step S1120. Then, the printer 104 prints the print data. With this, a printed matter is obtained.

In a step S1122, the printer 104 forms double punched holes at predetermined positions in the printed matter obtained in the step S1121 based on the information related to execution of the punched hole-forming function, included in the print capabilities information received in the step S1121. With this, the printed matter formed with the double punched holes is obtained.

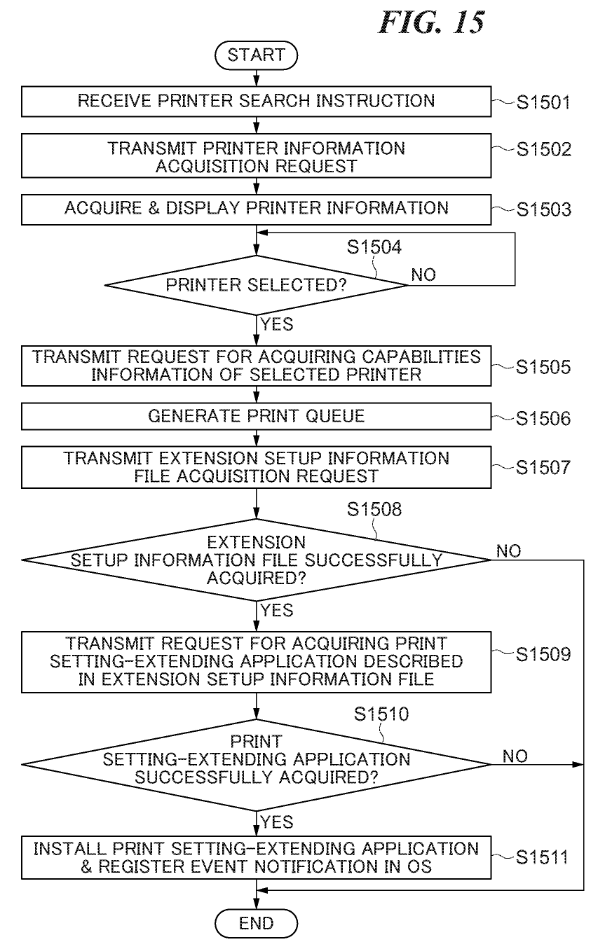

FIG. 15 is a flowchart of a process for installing the print setting-extending application 512 into the client terminal 101. A program for the process in FIG. 15 has been stored in the storage section 214 of the client terminal 101 in advance and is executed by the CPU 212. Referring to FIG. 15, in a step S1501, the CPU 212 of the client terminal 101 receives a printer search instruction according to the operation of pressing the object 601 on the setup screen 600 (see FIG. 7).

In a step S1502, the CPU 212 transmits a request for acquiring printer information to be registered in the client terminal 101 to the printer 104. The printer name of the printer 104 and the HWID of the printer 104 are transmitted from the printer 104 as the printer information in response to this request.

In a step S1503, the CPU212 acquires the printer information transmitted from the printer 104 and displays the acquired printer information on the display section 216. With this, the printer list is displayed in the area 602 on the setup screen 600.

In a step S1504, the CPU 212 determines whether or not one printer has been selected from the printer list in the area 602. If it is determined in the step S1504 that one printer has been selected, the process proceeds to a step S1505. On the other hand, if it is determined in the step S1504 that one printer has not been selected, the process remains in the step S1504.

In the step S1505, the CPU 212 transmits a request for acquiring capabilities information of the printer selected in the step S1504 to the printer 104. With this, the capabilities information is transmitted from the printer 104 as a response. The CPU 212 can acquire this capabilities information.

In a step S1506, the CPU 212 updates the printer capabilities information having been stored and at the same time generates a print queue, based on the capabilities information acquired from the printer 104.

In a step S1507, the CPU 212 transmits a request for acquiring the extension setup information file 1000 to the online support service 521. This acquisition request includes the HWID of the printer.

In a step S1508, the CPU 212 determines whether or not the extension setup information file 1000 has been successfully acquired. If it is determined in the step S1508 that the extension setup information file 1000 has been successfully acquired, the process proceeds to a step S1509. On the other hand, if it is determined in the step S1508 that the extension setup information file 1000 has not been successfully acquired, i.e. acquisition of the extension setup information file 1000 has failed, the process is terminated.

In the step S1509, the CPU 212 acquires the application identifier of the print setting-extending application 512 from the extension setup information file 1000. Then, the CPU 212 transmits a request for acquiring the print setting-extending application 512 to the application management service 531 by designating the application identifier.

In a step S1510, the CPU 212 determines whether or not the print setting-extending application 512 has been successfully acquired. If it is determined in the step S1510 that the print setting-extending application 512 has been successfully acquired, the process proceeds to a step S1511. On the other hand, if it is determined in the step S1510 that acquisition of the print setting-extending application 512 has failed, the process is terminated.

In the step S1511, the CPU 212 installs the print setting-extending application 512 acquired in the step S1510 to thereby register the application identifier of the print setting-extending application 512 in a state associated with the print queue. Further, the CPU 212 performs registration indicating an event notification timing to the OS 513. Here, the registration is performed such that an event is notified to the print setting-extending application 512 in a case where a print queue associated with the print setting-extending application 512 is selected on the print setting screen 1400 (see FIG. 11B).

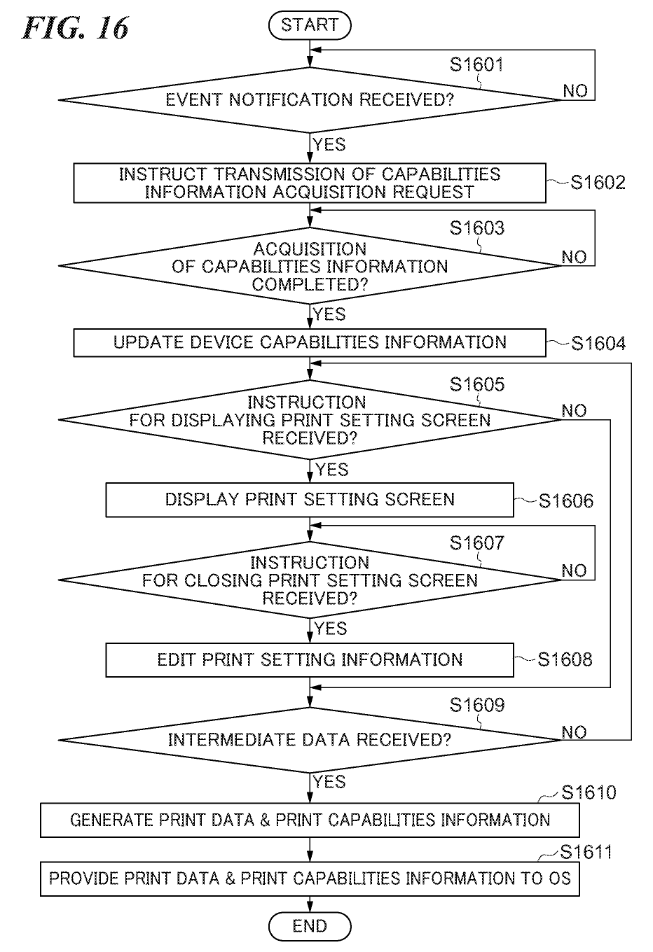

FIG. 16 is a flowchart of a process for generating print data by making print settings with the print setting-extending application. A program for the process in FIG. 16 has been stored by the print setting-extending application 512, and is loaded into the memory 213 and executed by the CPU 212. Referring to FIG. 16, in a step S1601, the CPU 212 of the client terminal 101 determines whether or not an event notification has been received. The event is an event issued by the OS 513, for notifying the print setting-extending application 512 that the event notification has been registered in the step S1511 (see FIG. 15). If it is determined in the step S1601 that the event notification has been received, the process proceeds to a step S1602. On the other hand, if it is determined in the step S1601 that the event notification has not been received, the process remains in the step S1601.

In the step S1602, the CPU 212 transmits a request for acquiring the capabilities information (printer information) with respect to setting items set to the print setting-extending application 512 to the printer 104. Here, acquisition of the capabilities information is also requested with respect to a setting item which has not been acquired in the step S1502 (see FIG. 15).

In a step S1603, the CPU 212 determines whether or not acquisition of the capabilities information requested in the step S1602 has been completed. If it is determined in the step S1603 that acquisition of the capabilities information has been completed, the process proceeds to a step S1604. On the other hand, if it is determined in the step S1603 that acquisition of the capabilities information has not been completed, the process remains in the step S1603.

In the step S1604, the CPU 212 updates the device capabilities information based on the capabilities information, which is determined to have been acquired in the step S1603. With this, also with respect to the setting item which has not been acquired by the OS 513, the capabilities information is stored in the storage section 214 of the client terminal 101.

In a step S1605, the CPU 212 determines whether or not an instruction for displaying the print setting screen 1400 (see FIG. 11B) generated by the print setting-extending application 512 has been received. The instruction for displaying the print setting screen 1400 generated by the print setting-extending application 512 is an instruction issued based on an operation performed with respect to the object 1404 on the print setting screen 1400. If it is determined in the step S1605 that the display instruction has been received, the process proceeds to a step S1606. On the other hand, if it is determined in the step S1605 that the display instruction has not been received, the process proceeds to a step S1609.

In the step S1606, the CPU 212 displays the detailed setting screen 1300 (see FIG. 12) on the display section 216 based on the device capabilities information updated in the step S1604. With this, it is possible to receive an operation of the user, performed on the detailed setting screen 1300.

In a step S1607, the CPU 212 determines whether or not an instruction for terminating the display of the print setting screen 1400 generated by the print setting-extending application 512, i.e. an instruction for closing the print setting screen 1400 has been received. If it is determined in the step S1607 that the display termination instruction has been received, the process proceeds to a step S1608. On the other hand, if it is determined in the step S1607 that the display termination instruction has not been received, the process remains in the step S1607.

In the step S1608, the CPU 212 edits the print setting information with the settings selected on the print setting screen 1400. After this editing, the CPU 212 terminates the display of the print setting screen 1400.

In the step S1609, the CPU 212 determines whether or not the print setting-extending application 512 has received the intermediate data from the OS 513. If it is determined in the step S1609 that the intermediate data has been received, the process proceeds to a step S1610. On the other hand, if it is determined in the step S1609 that the intermediate data has not been received, the process returns to the step S1605, and the step S1605 et seq. are sequentially executed.

In the step S1610, the CPU 212 generates print data and print capabilities information based on the intermediate data (including the print setting information) received by the print setting-extending application 512 (generation step). The print data is the image data of the predetermined format. The print capabilities information includes the information related to the punched hole setting received on the detailed setting screen 1300. This print capabilities information is described as the attribute values defined by the IPP. Note that in the print capabilities information, another description form can be used. With this, for example, setting items and attribute values, uniquely defined by the printer vendor, can also be included in the print capabilities information.

In a step S1611, the CPU 212 transmits (provides) the print data and the print capabilities information, generated in the step S1610, to the OS 513. With this, execution of the punched hole-forming function based on the punched hole setting received on the detailed setting screen 1300 is instructed (instruction step).

As described above, in the client terminal 101, even in a case where the general-purpose printer driver 511 which does not sufficiently support execution of the punched hole-forming function is used, it is possible to cause the printer 104 to execute the punched hole-forming function by using the print setting-extending application 512.

According to the present disclosure, even in a case where the standard driver is used, it is possible to cause the image forming system to execute the punched hole-forming function.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU),

micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-024273, filed February 18, 2025, which is hereby incorporated by reference herein in its entirety.

What is claimed is:

1. A non-transitory computer-readable storage medium storing an application program, the application program causing a computer of an information processing apparatus to execute a control method,
the control method comprising:
supporting a standard driver provided from a provider of an operating system;
displaying a setting reception screen for receiving a punched hole setting for causing an image forming system having a punched hole-forming function which can form punched hole sets each formed by a plurality of punched holes, at a plurality of positions, to execute the punched hole-forming function; and
instructing execution of the punched hole-forming function based on the punched hole setting received on the setting reception screen.

2. The non-transitory computer-readable storage medium according to claim 1, wherein the control method further comprises acquiring capabilities information related to capabilities which can be executed by the image forming system, from the image forming system, before displaying the setting reception screen, and
wherein the displaying of the setting reception screen includes displaying the setting reception screen in a case where information which enables the image forming system to execute the punched hole-forming function is included in the capabilities information acquired by the acquiring, and inhibiting displaying of the setting reception screen in a case where the information which enables the image forming system to execute the punched hole-forming function is not included in the capabilities information.

3. The non-transitory computer-readable storage medium according to claim 2, wherein the displaying of the setting reception screen includes displaying, when the displaying of the setting reception screen is inhibited, a screen from which the punched hole setting is omitted, in place of the displaying of the setting reception screen.

4. The non-transitory computer-readable storage medium according to claim 1, the control method further comprises generating image data including information related to the punched hole setting received on the setting reception screen, and
wherein the instructing includes transmitting the image data generated by the generating, as an instruction for executing the punched hole-forming function.

5. The non-transitory computer-readable storage medium according to claim 4, wherein the setting reception screen includes a preview image of the image data, and
wherein in the preview image, positions where each set of the punched holes are to be formed are visualized.

6. The non-transitory computer-readable storage medium according to claim 1, wherein the setting reception screen includes, as the punched hole setting, at least one of an execution selection section for selecting whether or not to execute the punched hole-forming function, a type selection section for selecting a type of a working tool which is disposed in the image forming system and used for execution of the punched hole-forming function, a name selection section for selecting a name of the working tool, and a position selection section for selecting positions where each set of the punched holes are to be formed.

7. The non-transitory computer-readable storage medium according to claim 1, wherein the setting reception screen includes a fine adjustment section for finely adjusting, in a state in which the positions where each set of the punched holes are to be formed have been selected by the position selection section, the selected positions where each set of the punched holes are to be formed.

8. The non-transitory computer-readable storage medium according to claim 1, wherein the standard driver is a program which cannot receive the punched hole setting.

9. The non-transitory computer-readable storage medium according to claim 1, wherein the standard driver is a program operating based on the Internet Printing Protocol.

10. A control method comprising:
supporting a standard driver provided from a provider of an operating system;
displaying a setting reception screen for receiving a punched hole setting for causing an image forming system having a punched hole-forming function which can form punched hole sets each formed by a plurality of punched holes, at a plurality of positions, to execute the punched hole-forming function; and
instructing execution of the punched hole-forming function based on the punched hole setting received on the setting reception screen.

11. An information processing apparatus including an application program, the application program causing a computer of the information processing apparatus to execute a control method comprising:
supporting a standard driver provided from a provider of an operating system;
displaying a setting reception screen for receiving a punched hole setting for causing an image forming system having a punched hole-forming function which can form punched hole sets each formed by a plurality of punched holes, at a plurality of positions, to execute the punched hole-forming function; and
instructing execution of the punched hole-forming function based on the punched hole setting received on the setting reception screen.
